(19) United States
(12) Patent Application Publication
(10) Pub. No.: US 2015/0184746 A1
(43) Pub. Date: Jul. 2, 2015

(54) NON-METALLIC AND NON-MAGNETIC PNEUMATIC ACTUATOR

(71) Applicants: MING-CHANG SHIH, TAINAN CITY (TW); HUNG-LUNG HUANG, NEW TAIPEI CITY (TW)

(72) Inventors: MING-CHANG SHIH, TAINAN CITY (TW); HUNG-LUNG HUANG, NEW TAIPEI CITY (TW)

(21) Appl. No.: 14/141,680

(22) Filed: Dec. 27, 2013

(51) Int. Cl. F16J 1/01

(52) U.S. Cl. CPC F16J 1/01

(57) ABSTRACT

A non-metallic and non-magnetic pneumatic actuator is revealed herein to have a piston rod and an end cap both made of PTFE, a cylinder made of PTFE and graphite, a cushion, and at least one sealing piece. The non-metallic and non-magnetic pneumatic actuator can work in the strong magnetic fields, electromagnetic interference or metal prohibited environment.

### BACKGROUND OF THE INVENTION

1. Field of the Invention

The present invention relates to a non-metallic and non-magnetic pneumatic actuator mainly made of PTFE. PTFE has many unique properties, which make it valuable in scores of applications, e.g. low friction thereof for allowing the pneumatic actuator to move in an exceptionally smooth and steady manner. Furthermore, such a non-metallic and non-magnetic pneumatic actuator can be unaffected by magnetic fields and electromagnetic interference and has a less weight as essential advantages.

2. Description of Related Art

A conventional pneumatic actuator is shown in FIG. 3, comprising a piston rod (1a), a cylinder (2a), an end cap (3a), sealing pieces (4a), and a cushion (5a).

Conventional pneumatic actuators are typically made of stainless steel, steel, metal alloys, etc., and are usually driven by compressed air passing into the cylinder. When used in combination with electric equipment, pneumatic actuators are always susceptible to magnetic fields and to electromagnetic wave generated from electric equipment. These cause the poor performance of pneumatic actuators.

### SUMMARY OF THE INVENTION

In view of the above-mentioned problems, the object of the present invention is to provide a non-metallic and non-magnetic pneumatic actuator, comprising a cylinder made of PTFE (polytetrafluoroethene) added with graphite, wherein the cylinder has a cavity therein and the cavity has an open end, a movable piston rod made of PTFE (100 wt. %) disposed inside the cavity for moving in and out of the open end of the cavity according to changes of air pressure in the cavity, a cushion disposed on an end away from the open end of the cavity for preventing a collision between the piston rod and the cylinder, an end cap made of PTFE (100 wt. %) for covering the open end of the cylinder, and at least one sealing piece for sealing a junction of the cylinder and the end cap.

According to an embodiment of the present invention, the cylinder is made of PTFE added with 15˜35 wt. % graphite, preferably 25 wt. % graphite.

In order to make an actuator work better than conventional ones, various materials, processing error, and design parameters are taken into consideration and modified herein to manufacture a non-metallic and non-magnetic pneumatic actuator of the present invention. In use of the pneumatic actuator, the piston rod made of PTFE can be driven in an exceptionally smooth and steady manner by introducing compressed air into the cavity of the cylinder due to PTFE having a low friction property. Moreover, graphite is added to material of the cylinder wall for enhancing durability of the pneumatic actuator.

According to an embodiment of the present invention, the non-metallic and non-magnetic pneumatic actuator is different from conventional pneumatic actuators that it does not generate magnetic attraction and induction. Moreover, in the magnetic fields and electromagnetic interference environment, the non-metallic and non-magnetic pneumatic actuator can prevent unstable operation.

### BRIEF DESCRIPTION OF THE DRAWINGS

FIG. 1 is a stereogram showing a non-metallic and non-magnetic pneumatic actuator according to the present invention;

FIG. 2 is a cross-sectional view showing the structure of a non-metallic and non-magnetic pneumatic actuator according to the present invention;

FIG. 3 is a cross-sectional view showing the structure of a conventional pneumatic actuator.

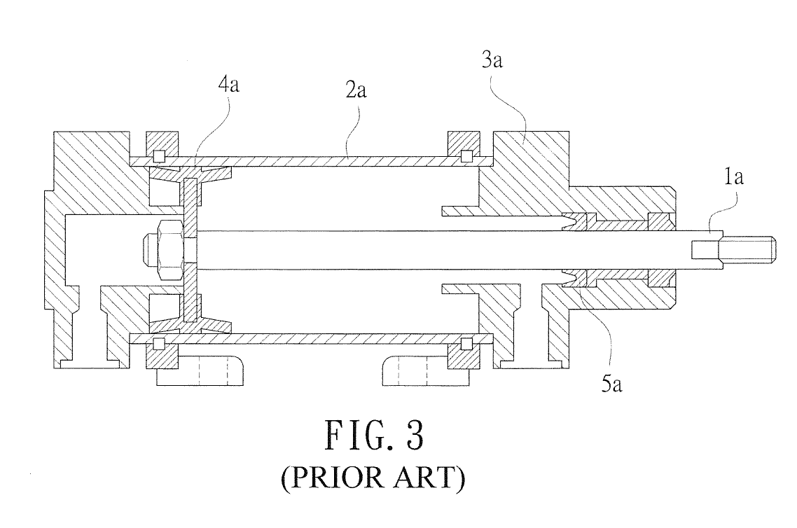

### DETAILED DESCRIPTION OF THE PREFERRED EMBODIMENT

Hereinafter, an exemplary embodiment of the present invention will be described in detail with reference to the accompanying drawings.

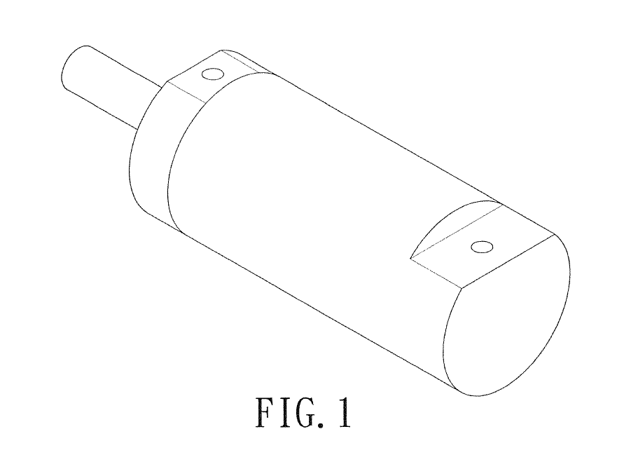

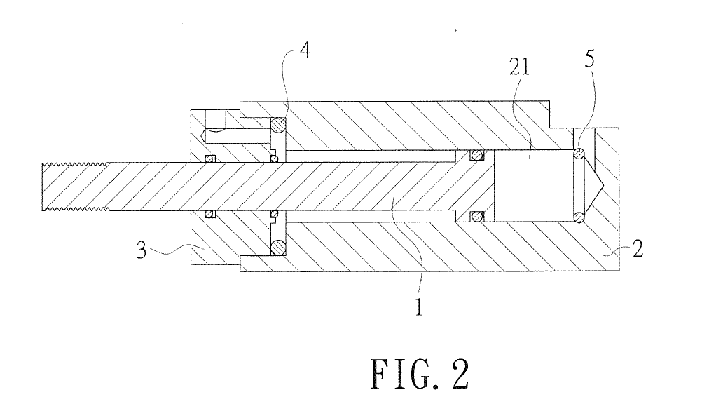

Referring to FIG. 1 and FIG. 2, a non-metallic and non-magnetic pneumatic actuator is disclosed, comprising

a cylinder (2) made of PTFE (polytetrafluoroethene) added with 15˜35 wt. % (preferably 25 wt. %) graphite, wherein the cylinder (2) has a cavity (21) therein and the cavity (21) has an open end;

a movable piston rod (1) made of PTFE (100 wt. %) disposed inside the cavity (21) for moving in and out of the open end according to changes of air pressure in the cavity (21);

a cushion (5) disposed on an end away from the open end of the cavity (21) for preventing a collision between the piston rod (1) and the cylinder (2);

an end cap (3) made of PTFE (100 wt. %) for covering the open end of the cylinder (2); and

at least one sealing piece (4) for sealing a junction of the cylinder (2) and the end cap (3).

The present invention aims at improving the problem of conventional actuators, i.e. susceptibility to electromagnetic interference. In use of the pneumatic actuator, the piston rod (1) can be driven by introducing compressed air into the cavity (21) of the cylinder (2) and to can move in and out of the open end of the cylinder (2) according to changes of air pressure in the cavity (21). The sealing pieces (4) are used to seal the junction of the cylinder (2) and the end cap (3) for preventing air-leakage, and the cushion (5) is used to prevent damage which may cause by a collision between the piston rod (1) and the cylinder (2).

It is worth mentioning that a weight percentage of added graphite is not particularly restricted, but preferably 15˜35 wt. %, more preferably 25 wt. %. When the weight percentage of added graphite is lower than 15 wt. %, the decreased strength of the cylinder causes low durability to a pneumatic actuator. When it is higher than 35 wt. %, the increased electric conductivity and brittleness may respectively lead to electromagnetic interference and a low yield rate of the pneumatic actuator.

Hereinafter, an exemplary embodiment of the present invention will be described in detail with reference to the accompanying drawings.

### EXAMPLE 1

Prepare a general pneumatic actuator made of metal alloy and a non-metallic and non-magnetic pneumatic actuator primarily made of Teflon® material. Then use an enameled wire to generate a small magnetic field (about 20 μTesla) for examining the magnetic effect on a metal alloy pneumatic actuator and a non-metallic and non-magnetic pneumatic actuator. The result showed that when the magnetic enameled wire close to a metal alloy pneumatic actuator, a relatively large magnetic field induced due to the interaction between metal components is of the pneumatic actuator and magnetic enameled wire. After the magnetic enameled wire is removed, the induced magnetic field is 16.53 μT. However, by using the same way to examine magnetic effect on a non-magnetic pneumatic actuator, the result showed that the induced magnetic field is only 0.02 μT. It is worth mentioning that the induced magnetic field may change according to the size or shape of pneumatic actuator. However, in comparison with conventional pneumatic actuators, the induced magnetic field of the non-metallic and non-magnetic pneumatic actuator is significantly lower than that of conventional ones with the same size and shape.

According to the above description, in comparison with the traditional technique, the non-metallic and non-magnetic pneumatic actuator does not generate magnetic attraction and induction. Moreover, in a magnetic fields or an environment subject to electromagnetic interference, the non-metallic and non-magnetic pneumatic actuator can prevent the problem of unstable operation.

To sum up, a non-metallic and non-magnetic pneumatic actuator according to the present invention continues to use the same internal structure of conventional actuators, but adopts different materials from those of conventional pneumatic actuators after referring parameters of various material properties as well as processing errors and accurately calculating design parameters. After went through a long period of hard studies and several tests, inventors finally processed and manufactured the non-metallic and non-magnetic pneumatic actuator of the present invention.

What is claimed is:

1. A non-metallic and non-magnetic pneumatic actuator comprises:
a cylinder made of PTFE added with graphite, wherein the cylinder has a cavity therein and the cavity has an open end;
a movable piston rod made of PTFE disposed inside the cavity for moving in and out of the open end according to changes of air pressure in the cavity;
a cushion disposed on an end away from the open end of the cavity for preventing a collision between the piston rod and the cylinder;
an end cap made of PTFE for covering the open end of the cylinder; and
at least one sealing piece for sealing a junction of the cylinder and the end cap.

2. The non-metallic and non-magnetic pneumatic actuator as claimed in claim 1, wherein the cylinder is made of PTFE added with 15˜35 wt. % graphite.

3. The non-metallic and non-magnetic pneumatic actuator as claimed in claim 2, wherein the cylinder is made of PTFE added with 25 wt. % graphite.
